(19) United States
(12) Patent Application Publication
(10) Pub. No.: US 2011/0057439 A1
(43) Pub. Date: Mar. 10, 2011

(54) HIGH PRESSURE CAM AND GROOVE CONNECTOR

(76) Inventors: Thomas E. Kariniemi, Flagstaff, AZ (US); Chad R. Taszarek, Albertville, MN (US)

(21) Appl. No.: 12/991,621

(22) PCT Filed: Apr. 30, 2009
(86) PCT No.: PCT/US09/42234

§ 371 Date: Nov. 8, 2010

Related U.S. Application Data
(60) Provisional application No. 61/051,868, filed on May 9, 2008.

(51) Int. Cl. F16L 55/00

(52) U.S. Cl. 285/85

(57) ABSTRACT

A cam and groove coupling is provided for fluid transfer applications at elevated fluid pressures e.g. 1000 psi. This coupler also allows a user to connect and disconnect hoses and guns without the use of tools. The profile of the cam is such that it will not allow the male section to be disconnected or released from the female section unless both handles are in the full open position. In addition, the cam profile is such that, when subjected to pressure, it requires substantial force to release the levers making it difficult to manipulate the handles under pressure.

### TECHNICAL FIELD

This application claims the benefit of U.S. Application Ser. No. 61/051,868, filed May 9, 2008, the contents of which are hereby incorporated by reference.

### BACKGROUND ART

Cam and groove connectors are popular in providing quick release connections. One limitation of such prior art connectors is they have typically been limited to 250 psi or so.

### DISCLOSURE OF THE INVENTION

The purpose of this invention is to allow for no-tools connection and removal of fittings in elevated fluid pressure applications such paint sprayers, texture pumps and other fluid transfer applications. The construction and operation are quite simple. The body is composed of an aluminum extrusion and the handles are powder metal. The handle is assembled to the extrusion with a pin though the handle and press-fit into the extrusion body. A rubber gasket inserted inside the female member and is used as a face seal between the male and female members. The connection is made by rotating the handles to the full open position, inserting the male member, and rotating the handles to the fully closed position securing the two components together.

The instant invention allows a user to utilize a cam and groove coupling in fluid transfer applications at elevated fluid pressures e.g. 1000 psi. This coupler also allows a user to connect and disconnect hoses and guns without the use of tools. The profile of the cam is such that it will not allow the male section to be disconnected or released from the female section unless both handles are in the full open position which, in the preferred embodiment, requires handle rotation of about 162 degrees. In addition, the cam profile is such that when subjected to pressure, it requires substantial force to release the levers making it difficult to manipulate handle under pressure. Compared to a standard prior art cam and groove fitting, this design provides an increased length of engagement between the male and female members, and an increased diameter of the cam surface on the lever and the mating male member. The pressure angle in the preferred embodiment of about 59.5 degrees between the male fitting and the cam lever is such that it resists opening when subjected to pressure.

These and other objects and advantages of the invention will appear more fully from the following description made in conjunction with the accompanying drawings wherein like reference characters refer to the same or similar parts throughout the several views.

### BRIEF DESCRIPTION OF DRAWINGS

FIG. 1 is an exploded view showing the fitting of the instant invention.

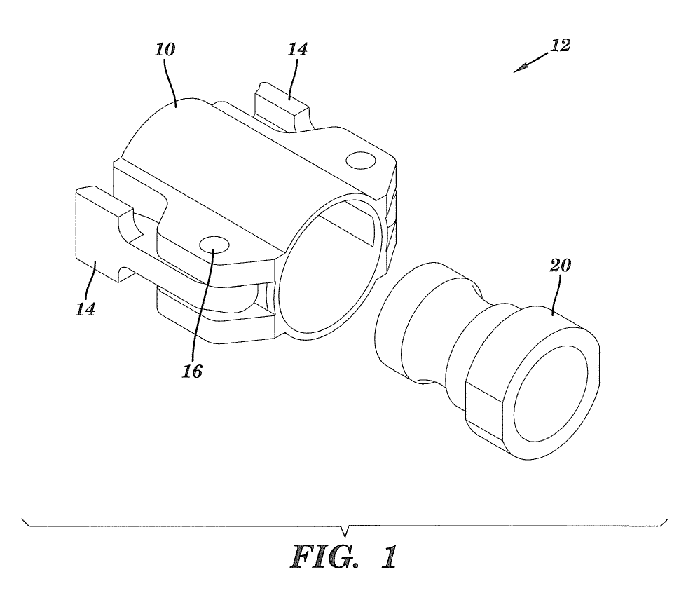

FIG. 2 is a cross-section of the fitting of the instant invention in the open position.

FIG. 3 is a cross-section of the fitting of the instant invention in the partially open but not removable position.

FIG. 4 is a cross-section of the fitting of the instant invention in the closed position.

### BEST MODE FOR CARRYING OUT THE INVENTION

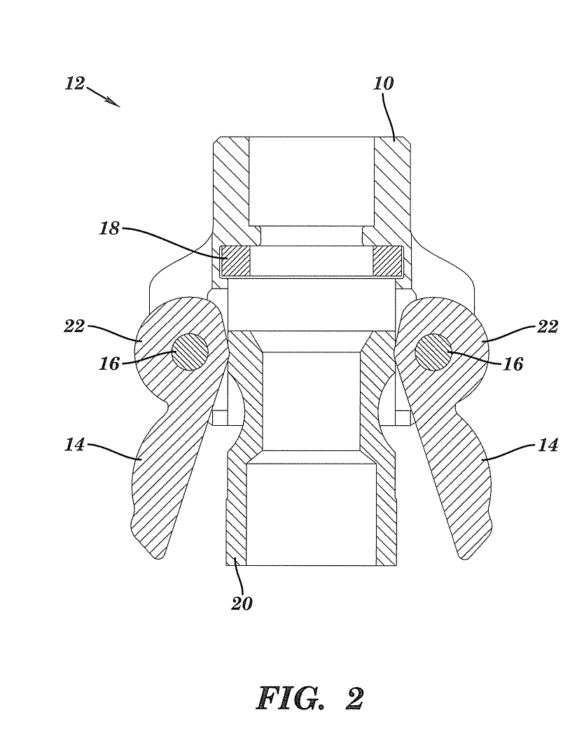

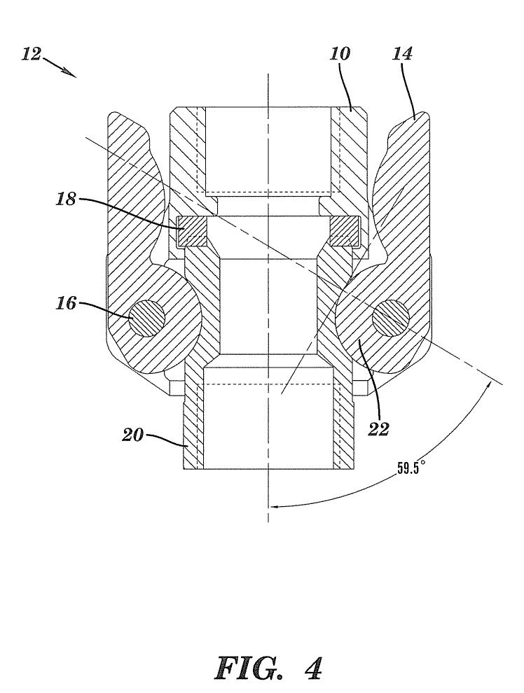

The body 10 (or female member) of the fitting 12 is constructed of an aluminum extrusion and the handles 14 are powder metal. The handles 14 are assembled to the extrusion body 10 with a pin 16 though the handle 14 and press-fit into the extrusion body 10. A rubber gasket 18 is inserted inside the female member 10 and is used as a face seal between the male 20 and female 10 members. The connection is made by rotating the handles 14 to the full open position of FIG. 2, inserting the male member 20, and rotating the handles 14 to the fully closed position of FIG. 4 securing the two components together. In the preferred embodiment, both male 20 and female members are machined from aluminum extrusions.

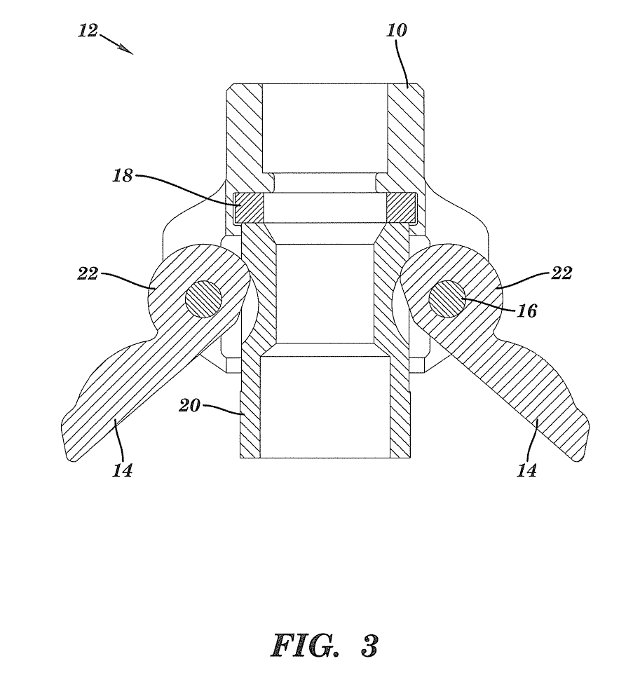

The profile of the cam 22 on handle/lever 14 is such that it will not allow the male member 20 to be disconnected or released from the female section 10 unless both handles 14 are in the full open position which, in the preferred embodiment, requires handle rotation of about 162 degrees. FIG. 3 shows that when rotated 130 degrees, handles 14 still secure the male 20 and female 10 members together.

In addition, the cam 22 profile is such that when subjected to pressure, it requires substantial force to release the levers making it difficult to manipulate handle under pressure. As can be seen in FIG. 4, compared to a standard prior art cam and groove fitting, this design provides an increased length of engagement between the male 20 and female 10 members, and an increased diameter of the cam surface 22 on the lever 14 and the mating male member 20. The pressure angle in the preferred embodiment of about 59.5 degrees between the male fitting and the cam lever is such that it resists opening when subjected to pressure as can be seen in FIG. 4.

It is contemplated that various changes and modifications may be made to the fitting without departing from the spirit and scope of the invention as defined by the following claims.

1. In a cam and groove coupling having male and female members, said male member comprising a circumferential groove and said female member having at least first and second cams rotatable about a pin between a closed position for engaging said groove and an open position for allowing insertion and removal of said male member, the improvement comprising said cams having a geometry such that both handles need be in the full open position to allow removal of said male member.

2. The cam and groove coupling of claim 1 wherein said handle rotation from closed to open positions is about 162 degrees.

3. The cam and groove coupling of claim 1 further comprising a pressure angle and wherein said pressure angle is about 59.5 degrees between the male fitting and the cam lever to resist opening when subjected to pressure.
